(19) United States
(12) Patent Application Publication
(10) Pub. No.: US 2005/0121139 A1
(43) Pub. Date: Jun. 9, 2005

(54) System and method used in attaching die for ball grid arrays

(75) Inventors: Mark Gerald M. Cruz, Baguio City (PH); Jerry G. Cayabyab, Baguio City (PH)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/726,983

(22) Filed: Dec. 3, 2003

(51) Int. Cl. B32B 31/00

(52) U.S. Cl. 156/297; 156/560

(57) ABSTRACT

According to one embodiment of the invention, a method used in attaching die to a substrate includes providing a substrate having a plurality of die attach regions, positioning a dispensing tool having an aperture adjacent a respective one of the die attach regions, positioning the aperture proximate the respective die attach region, dispensing an adhesive through the aperture and onto the respective die attach region, and translating the dispensing tool in a direction perpendicular to a length of the aperture while dispensing the adhesive to form an adhesive region on the respective die attach region. A length of the aperture is greater than a width of the aperture.

### TECHNICAL FIELD OF THE INVENTION

This invention relates generally to the field of integrated circuit packaging and, more specifically, to a system and method for attaching die for ball grid arrays (“BGAs”).

### BACKGROUND OF THE INVENTION

Because of the sheer volume of integrated circuits in the marketplace, packaging of integrated circuits in a manner that is cost-effective with high yield is important for semiconductor manufacturers in order to be competitive in the marketplace. One important process in the fabrication of integrated circuits, such as ball grid arrays (“BGAs”), is the die attach process.

One problem during the die attach process for BGAs with large die size is insufficiency of epoxy coverage. Epoxy voids may occur once the dispense pattern is not properly optimized because there is a possibility of air entrapment. This may lead to material rejection, which hurts yield, or poor reliability. Package cratering is also a possibility due to insufficient epoxy coverage.

### SUMMARY OF THE INVENTION

According to one embodiment of the invention, a method used in attaching die to a substrate includes providing a substrate having a plurality of die attach regions, positioning a dispensing tool having an aperture adjacent a respective one of the die attach regions, positioning the aperture proximate the respective die attach region, dispensing an adhesive through the aperture and onto the respective die attach region, and translating the dispensing tool in a direction perpendicular to a length of the aperture while dispensing the adhesive to form an adhesive region on the respective die attach region. A length of the aperture is greater than a width of the aperture.

Some embodiments of the invention provide numerous technical advantages. Other embodiments may realize some, none, or all of these advantages. For example, a modified dispense tool that includes an aperture with a length approximately equal to the length of a die desired to be attached to a substrate assures sufficient epoxy coverage when the travel of the dispense tool approximately equals the width of the die. Sufficient epoxy coverage substantially reduces or eliminates epoxy voids and package cratering, which enhances yield and quality/reliability of the completed integrated circuits.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is perspective view of a dispensing tool according to one embodiment of the invention; and

FIGS. 2A through 2C are perspective views illustrating the dispensing of an adhesive on a die attach region of a substrate utilizing the dispensing tool of FIG. 1 according to one embodiment of the invention.

### DETAILED DESCRIPTION OF EXAMPLE EMBODIMENTS OF THE INVENTION

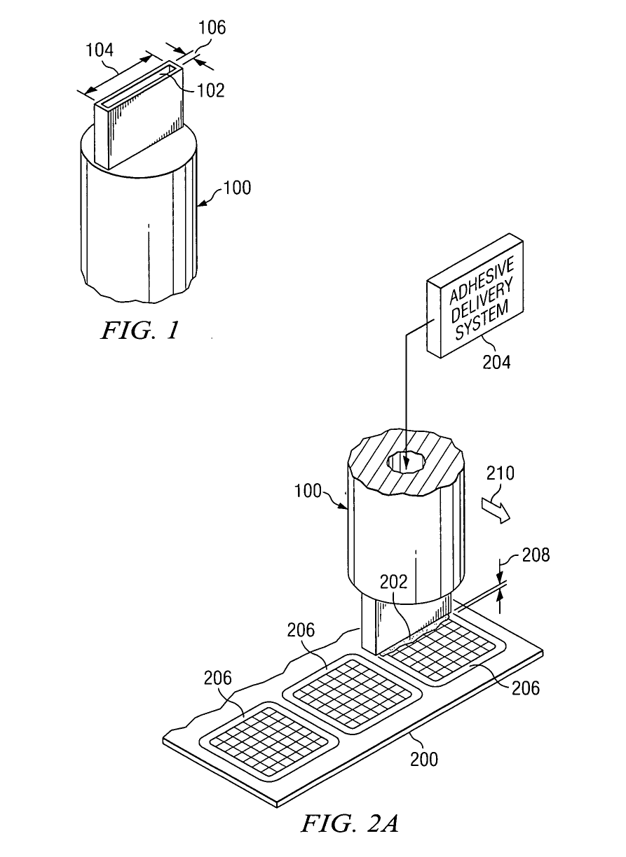

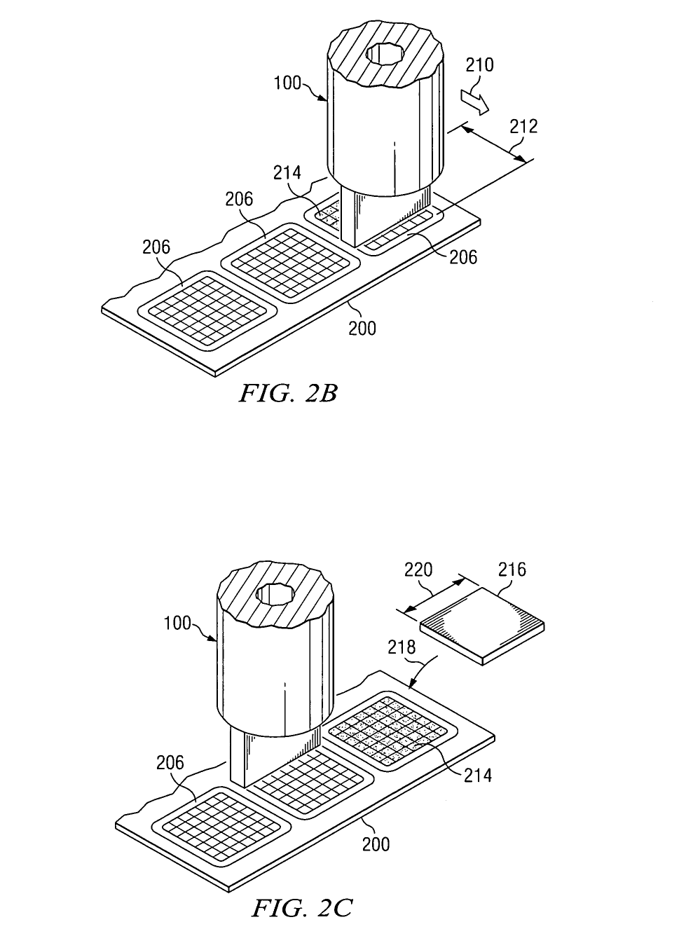

Example embodiments of the present invention and their advantages are best understood by referring now to FIGS. 1 through 2C of the drawings, in which like numerals refer to like parts.

FIG. 1 is a perspective view of a dispensing tool 100 according to one embodiment of the present invention. As described in more detail below in conjunction with FIGS. 2A through 2C, dispensing tool 100 functions to dispense an epoxy or other suitable adhesive on a substrate to ensure sufficient epoxy coverage for integrated circuit die that are subsequently attached to the substrate. This substantially reduces or eliminates epoxy voids and/or package cratering that may develop during the fabrication of integrated circuit packages. These problems have been discovered using prior die attach techniques, such as the writing dispense method and the stamping dispense method. The writing dispense method utilizes a dispensing tool have a circular aperture that creates a pattern of adhesive on a substrate by directing the dispensing tool in a particular pattern while dispensing the epoxy. The most common configuration is an “X” shape. The stamping dispense method utilizes a plurality of circular apertures arranged in a particular pattern that create a pattern of adhesive by “stamping” the material onto the surface of the substrate in a vertical stamping motion only. This pattern is also in the general shape of an “X”. Both of these die attach techniques often lead to epoxy voids and/or package cratering, especially for the larger die sizes that have recently become more prevalent. The apertures used in these prior techniques are circular because most epoxy materials in the industry are easy to dispense (less viscous). Using non-circular apertures, such as square or rectangular, that have corners would generate residue on the corners, thus making the aperture smaller over time.

The present invention addresses these problems by providing, in one embodiment, dispensing tool 100 with a rectangular aperture 102 having a greater length 104 than a width 106. This facilitates the dispensing of an amount of epoxy or other suitable adhesive to a die attach region of a substrate that matches the general shape of a die desired to be attached to the substrate when the dispensing tool is translated in a direction that is perpendicular to length 104. This is described in more detail below in conjunction with FIGS. 2A through 2C. Although illustrated in FIG. 1 as being the shape of a rectangle, aperture 102 may resemble other suitable configurations having a greater length than width. For example, aperture 102 may resemble the shape of a parallelogram, a trapezoid, a triangle, an ellipse, an oval, or other suitable shapes. Dispensing tool 100 may be formed from any suitable material, such as a tool steel, and any suitable automated machinery may be utilized to translate dispensing tool 100.

In one embodiment, the size and shape of aperture 102 depends on the size and shape of the integrated circuit die that is desired to be attached to a substrate. Because most integrated circuit die are generally rectangular, aperture 102 includes length 104 being approximately equal to a length of the particular die that is desired to be attached to the substrate. In one embodiment, length 104 is between approximately three millimeters and nine millimeters and width 106 is between approximately 0.09 millimeters and 0.11 millimeters. Other suitable dimensions for aperture 102 is contemplated by the present invention.

FIGS. 2A through 2C are perspective views illustrating the dispensing of an adhesive 202 on a die attach region 206 of a substrate 200 utilizing dispensing tool 100 according to one embodiment of the invention. Adhesive 202 is typically an epoxy; however, adhesive 202 may be any suitable adhesive adapted to attach integrated circuit die to substrate 200. In addition, substrate 200 may be formed from any suitable flexible or rigid material; however, in one embodiment, substrate 200 is a tape substrate formed from polyimide. In the illustrated embodiment, adhesive 202 is delivered to dispensing tool 100 by an adhesive delivery system 204 for the purpose of dispensing adhesive 202 on one of a plurality of die attach regions 206 on substrate 200. Adhesive delivery system 204 may be any suitable delivery system operable to deliver adhesive to dispensing tool 100.

Referring to FIG. 2A, aperture 102 of dispensing tool 100 is positioned adjacent a respective die attach region 206. In order to dispense adhesive 202 on die attach region 206, aperture 102 is positioned with respect to die attach region 206 by an offset 208 that may be any suitable distance depending on the amount of adhesive 202 desired to be dispensed on die attach region 206. In one embodiment, offset 208 is approximately 0.10 to 0.11 millimeters from surface of die attach region 206; however, other suitable distances may also be utilized. Adhesive delivery system 204 then delivers adhesive 202 to dispensing tool 100 at a suitable rate. Once adhesive 202 starts forming on the surface of die attach region 206, dispensing tool 100 is translated in a direction perpendicular to length 104 of aperture 102 while continuing to dispense adhesive 202. The translation of dispensing tool 100 is illustrated in FIG. 2A by an arrow 210.

Referring to FIG. 2B, dispensing tool 100 has translated along a width 212 of die attach region 206 to form an adhesive region 214 thereon. The distance of width 212 is dependent upon the width of a particular die 216 (FIG. 2C) desired to be attached to die attach region 206. The adhesive delivery system 204 then stops the flow of adhesive 202 to dispensing tool 100 so that dispensing tool 100 may be moved to the next die attach region 206 to repeat the process of dispensing adhesive 202 thereon.

Referring to FIG. 2C, the movement of dispensing tool 100 to the next die attach region 206 is illustrated. As described above, any suitable method, such as automated machinery, may be utilized to control dispensing tool 100. Also illustrated is adhesive region 214 completed on the first die attach region 206. As illustrated, the configuration of adhesive region 214 resembles the configuration of die 216. As illustrated by arrow 218, die 216 may be attached to adhesive region 214 that now has sufficient adhesive coverage to substantially reduce or eliminate any voids or package cratering that have occurred in prior systems. This greatly enhances yield and quality/reliability of the completed integrated circuits. An advantage of utilizing dispensing tool 100 to form adhesive region 214 that resembles the configuration of die 216 is that large die sizes, such as die used for ball grid array packages, may be attached to die attach regions 206 of substrate 200 with greater assurance that no problems will occur during the die attach process.

Also illustrated in FIG. 2C is a length 220 of die 216 that, in one embodiment, approximately equals a length 104 of aperture 102. In this manner, and with reference to FIGS. 2A and 2B, a single sweeping motion by dispensing tool 100 may create adhesive region 214 in a cost efficient manner.

Although embodiments of the invention and their advantages are described in detail, a person skilled in the art could make various alterations, additions, and omissions without departing from the spirit and scope of the present invention, as defined by the appended claims.

1. A method used in attaching die to a substrate, comprising:
providing a polyimide substrate having a plurality of die attach regions;
positioning a dispensing tool having a rectangular aperture adjacent a respective one of the die attach regions, the rectangular aperture having a length greater than a width;
positioning the rectangular aperture proximate the respective die attach region;
dispensing an epoxy through the rectangular aperture and onto the respective die attach region;
translating the dispensing tool in a direction perpendicular to a length of the aperture while dispensing the adhesive to form an epoxy region on the respective die attach region; and
attaching a die to the epoxy region, a length of the die approximately equal to the length of the rectangular aperture.

2. The method of claim 1, wherein the length of the rectangular aperture is between approximately three and nine, and a width of the aperture is between approximately 0.09 millimeters and 0.11 millimeters.

3. The method of claim 1, wherein the width of the aperture is approximately 0.10 millimeters.

4. The method of claim 1, wherein positioning the rectangular aperture proximate the respective die attach region comprises positioning the rectangular aperture between 0.10 and 0.11 millimeters from the surface of the respective die attach region.

5. A system used in attaching die to a substrate, comprising:
a substrate having a plurality of die attach regions;
a dispensing tool comprising an aperture having a length greater than a width;
an adhesive delivery system operable to deliver an adhesive to the dispensing tool, the dispensing tool operable to dispense the adhesive through the aperture and onto a respective one of the plurality of die attach regions; and
a translation device operable to translate the dispensing tool in a direction perpendicular to the length of the aperture while dispensing the adhesive, whereby an adhesive region is formed on the respective die attach region.

6. The system of claim 5, wherein the aperture is rectangular.

7. The system of claim 6, wherein the length of the aperture is between approximately three and nine, and a width of the aperture is between approximately 0.09 millimeters and 0.11 millimeters.

8. The system of claim 6, further comprising a die attached to the adhesive region, wherein the length of the aperture is approximately equal to a length of the die.

9. The system of claim 5, wherein the dispensing tool is between 0.10 and 0.11 millimeters from the surface of the respective die attach region during the dispensing of the adhesive.

10. The system of claim 5, wherein the substrate is formed from a polyimide.

11. The system of claim 5, wherein the adhesive is an epoxy.

12. The system of claim 5, wherein dispensing tool is formed from a tool steel.

13. A method used in attaching die to a substrate, comprising:
providing a substrate having a plurality of die attach regions;
positioning a dispensing tool having an aperture adjacent a respective one of the die attach regions, the aperture having a length greater than a width;
positioning the aperture proximate the respective die attach region;
dispensing an adhesive through the aperture and onto the respective die attach region; and
translating the dispensing tool in a direction perpendicular to the length of the aperture while dispensing the adhesive to form an adhesive region on the respective die attach region.

14. The method of claim 13, wherein the aperture is rectangular.

15. The method of claim 14, wherein the length of the aperture is between approximately three and nine, and a width of the aperture is between approximately 0.09 millimeters and 0.11 millimeters.

16. The method of claim 14, further comprising attaching a die to the adhesive region, and wherein the length of the aperture is approximately equal to a length of the die.

17. The method of claim 13, wherein positioning the aperture proximate the respective die attach region comprises positioning the aperture approximately between 0.10 and 0.11 millimeters from the surface of the respective die attach region.

18. The method of claim 13, wherein the substrate is formed from a polyimide.

19. The method of claim 13, wherein the adhesive is an epoxy.

20. The method of claim 13, wherein dispensing tool is formed from a tool steel.
